(19) United States
(12) Patent Application Publication
(10) Pub. No.: US 2026/0297409 A1
(43) Pub. Date: Oct. 1, 2026

(54) Additives for Thermal Management Fluid and Thermal Management Fluid Compositions Including Same

(71) Applicants: SK Innovation Co., Ltd., Seould (KR); SK On Co., Ltd., Seoul (KR)

(72) Inventors: Kang Min JUNG, Daejeon (KR); Hak Mook KIM, Daejeon (KR); Ki Wan KIM, Daejeon (KR); Sang Hye SHIN, Daejeon (KR); Hong Won LEE, Daejeon (KR); Dong Gun LEE, Daejeon (KR); Jung A LEE, Daejeon (KR)

(21) Appl. No.: 19/576,196

(22) Filed: Mar. 24, 2026

(30) Foreign Application Priority Data
Mar. 25, 2025 (KR) 10-2025-0038278
Oct. 17, 2025 (KR) 10-2025-0150847

(51) Int. Cl. C09K 5/10

(52) U.S. Cl. CPC C09K 5/10

(57) ABSTRACT

An additive composition for a thermal management fluid, the composition comprising a phosphorus-based additive and a silicon-based additive. A thermal management fluid composition comprising the additive composition.

### CROSS REFERENCE TO RELATED APPLICATIONS

The present application claims priority to Korean Patent Application Nos. 10-2025-0038278, filed Mar. 25, 2025, and 10-2025-0150847, filed Oct. 17, 2025, the entire contents of which are incorporated herein by reference for all purposes.

### BACKGROUND

### Field

The present disclosure relates to an additive composition for a thermal management fluid and to a thermal management fluid composition including the same.

### Description of Related Art

Thermal management fluids refer to fluids designed to efficiently transfer and regulate thermal energy, and are primarily employed in cooling and heating systems.

A coolant functions to absorb heat generated from a heat source, thereby reducing the temperature of the heat source. Desirable properties of a coolant include high thermal efficiency, low viscosity, low cost, non-toxicity, chemical stability, and non-corrosiveness toward system components.

As electronic products such as electric vehicles continue to achieve higher performance levels, an increasing amount of heat is generated during their operation. To ensure reliable operation and to prevent a reduction in product lifespan, effective thermal control of heat generated within such products has become an essential consideration.

Immersion cooling is one of the cooling methods used for thermal management of electronic devices and computer systems. In immersion cooling, electronic devices are cooled through direct contact with a fluid, which enables more effective heat removal compared to conventional air-cooling or water-cooling methods.

Meanwhile, higher capacity batteries in modern electronic products face increased thermal runaway risks, causing battery fires. In an immersion cooling system, a thermal management fluid cools a battery by fully submerging the battery in the thermal management fluid, which isolates the battery from atmospheric oxygen and suppresses battery fires to a certain extent by creating an oxygen-deprived environment.

The foregoing is intended merely to aid in the understanding of the background of the present disclosure, and is not intended to mean that the present disclosure falls within the purview of the related art that is already known to those skilled in the art.

### SUMMARY

According to one aspect of the present disclosure, provided herein is an additive composition capable of improving fire propagation prevention performance of a thermal management fluid.

According to another aspect of the present disclosure, provided herein is a thermal management fluid composition comprising an additive composition.

An additive composition for a thermal management fluid according to one aspect of the present disclosure may comprise: a phosphorus-based additive; and a silicon-based additive.

According to one embodiment, the phosphorus-based additive may have a molecular weight of about 100 to about 500 g/mol.

According to one embodiment, the phosphorus-based additive may comprise a compound represented by Chemical Formula 1 below:

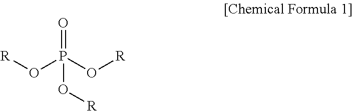

In Chemical Formula 1, each R may independently be hydrogen or a functional group having 1 to 30 carbon atoms, at least one R may not be hydrogen, and the total number of carbon atoms in the compound may be 1 to 30. In one embodiment, each functional group is independently a hydrocarbyl group.

According to one embodiment, the silicon-based additive may comprise a compound represented by Chemical Formula 2 below:

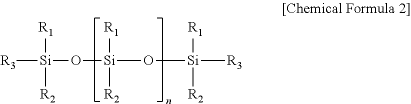

In Chemical Formula 2, functional groups R₁, R₂, and R₃ may each independently be selected from the group consisting of hydrogen, a hydroxyl group, an alkyl group, an alkenyl group, an alkynyl group, an aryl group, and an alkoxy group, and n may be an integer of equal to or greater than 1.

According to one embodiment, R₁ may be an alkyl group or an aryl group, and R₂ and R₃ may each independently be alkyl groups.

According to one embodiment, the weight ratio of the phosphorus-based additive to the silicon-based additive in the additive composition may be about 1:6 to about 10:1.

A thermal management fluid composition according to another aspect of the present disclosure may comprise: a base oil; a phosphorus-based additive; and a silicon-based additive.

According to one embodiment, the base oil may include mineral oil, synthetic oil, vegetable oil, or a combination thereof.

According to one embodiment, the thermal management fluid composition may comprise: about 85 wt % to about 98 wt % of the base oil; equal to or less than about 10 wt % of the phosphorus-based additive; and equal to or less than about 10 wt % of the silicon-based additive.

According to one embodiment, the thermal management fluid composition comprising the additive composition may have a flash point of at least about 200° C.

According to one embodiment, the thermal management fluid composition may further comprise a third additive. The third additive may comprise an antioxidant, an anti-foaming agent, a corrosion inhibitor, a detergent, a dispersant, a friction modifier, an anti-wear agent, an extreme-pressure additive, a viscosity index improver, a pour-point depressant, a viscosity modifier, or any combination thereof.

In one embodiment, the phosphorus-based additive comprises triethyl phosphate, tributyl phosphate, or a combination thereof.

In one embodiment, the silicon-based additive comprises polydimethylsiloxane.

In one embodiment, wherein R¹, R², and R³ are each methyl groups, and n is in a range of 8 to 16.

Also provided herein is a method of improving fire propagation prevention in a thermal management fluid, comprising adding the additive composition according to any embodiment disclosed herein (e.g., comprising a phosphorus- and silicon-based additive) to a base oil.

Also provided herein is a method of immersion cooling an electronic device, comprising contacting the device with the thermal management fluid composition according to any embodiment disclosed herein (e.g., comprising a base oil and an additive composition comprising a phosphorus- and silicon-based additive).

Also provided herein is a method of increasing the flash point of a thermal management fluid by at least 5° C., comprising adding the additive composition according to any embodiment disclosed herein (e.g., comprising a phosphorus- and silicon-based additive) to the thermal management fluid.

According to one embodiment, application of the additives can improve fire propagation prevention performance of a thermal management fluid.

According to one embodiment, the additives can effectively maintain functionality even under high-temperature conditions such as thermal runaway.

According to one embodiment, application of the additives can enhance the flash point of a thermal management fluid.

According to one embodiment, a thermal management fluid to which the additives are applied can be used as an immersion-cooling fluid.

### DETAILED DESCRIPTION

Hereinafter, the present disclosure will be described in detail. However, the following description is merely illustrative, and the present disclosure is not limited to the specific embodiments exemplarily described herein.

As will be described in more detail herein, the additive compositions comprise at least one phosphorus-based additive that decomposes at high temperatures to generate radicals that scavenge free radicals during combustion, thereby interrupting the chain reactions that sustain fire. The additive composition also comprises at least one silicon-based additive or a polysiloxane compound that generates silica through oxidative reactions during thermal decomposition, which blocks oxygen and inhibits flames through a smothering effect.

The additive compositions disclosed herein suppress fire propagation through dual mechanisms: chemical fire suppression (free radical scavenging by the phosphorus-based additive) and physical fire suppression (oxygen deprivation/smothering by silica generated from the silicon-based additive).

In certain embodiments, the additive compositions chemically suppress fire by increasing the flash point of the thermal management fluid by at least 5° C. (ΔFP≥5° C.), with specific examples achieving flash points of 204° C.-230° C. compared to 184° C. for the base oil alone. By improving the flash point of the thermal management fluid, the additive composition enables the use of base oils that were previously unsuitable for thermal management applications due to low flash points, thereby broadening formulation options.

Additionally, the additive compositions effectively maintain their flame-retardant functionality under extreme thermal conditions, including temperatures up to 1,000° C. or higher that occur during battery thermal runaway events. The additive compositions also perform their fire-suppression functions without impairing the cooling performance of the thermal management fluid when used in immersion cooling applications.

Advantageously, the additive compositions disclosed herein can be readily incorporated into conventional thermal management fluids without requiring specialized formulation changes.

### Additive Composition for Thermal Management Fluid

One aspect of the present disclosure provides an additive composition for a thermal management fluid. The additive composition comprises at least one phosphorus-based additive and at least one silicon-based additive. As used herein, the term “phosphorus-based additive” refers to an additive comprising a compound containing the element phosphorus (P). Additionally, the term “silicon-based additive” refers to an additive comprising a silicon-containing compound, and more in certain embodiments, may refer to an additive comprising an organosilicon compound.

The additive composition may be added to a thermal management fluid. The additive composition may be incorporated to suppress the propagation of fire from an electronic product (e.g., a battery) adjacent to the thermal management fluid to other products, components, or surrounding areas in the event of a fire. In certain embodiments, the additive composition may enhance the chemical fire suppression capability of the thermal management fluid. For example, during thermal runaway of a battery, the ambient temperature may rapidly increase to a temperature of 1,000° C. or higher. Under such extreme thermal conditions, the additive composition of the present disclosure may prevent the propagation of fire to adjacent battery cells, thereby minimizing damage caused by battery thermal runaway.

Combustion of a material proceeds through chain reactions in which free radicals are continuously generated and consumed. During combustion, the phosphorus-based additive decomposes to generate radicals that function to remove surrounding free radicals. In other words, the phosphorus-based additive may contribute to preventing fire propagation by interrupting the chain reactions through scavenging highly reactive free radicals generated during thermal decomposition at high temperatures.

The type of phosphorus-based additive is not particularly limited, provided that it is capable of performing the function described above. From the perspective of immersion cooling, the phosphorus-based additive is likewise not particularly limited, so long as it can perform the above-described role without impairing the immersion cooling performance of a thermal management fluid applied to electronic products.

For example, the phosphorus-based additive may have a molecular weight of equal to or less than about 500 g/mol. According to one embodiment, the molecular weight of the phosphorus-based additive may be about 100 to about 500 g/mol, about 100 to about 400 g/mol, about 100 to about 300 g/mol, or about 150 to about 300 g/mol. The phosphorus-based additive may be a small molecule (or a monomeric compound), an oligomer, or a polymer. Specifically, it may be a small molecule. When the additive is a small molecule, the molecular weight refers to a value calculated from the chemical formula. In the case of an oligomer or a polymer, the molecular weight refers to a weight average molecular weight. Additionally, for the oligomer or the polymer, the weight average molecular weight refers to a polystyrene-equivalent molecular weight measured by gel permeation chromatography (GPC).

According to another embodiment, the decomposition temperature of the phosphorus-based additive may be about 150° C. to about 450° C., about 170° C. to about 300° C., about 180° C. to about 250° C., or about 200° C. Decomposition temperature of the additive may be measured by methods known in the art, for example, thermogravimetric analysis (TGA) per ASTME1131 or ISO 11358. When the ambient temperature reaches the decomposition temperature, the phosphorus-based additive may undergo thermal decomposition and perform a flame-retardant function. However, when the molecular weight of the phosphorus-based additive exceeds the above-described range, the flame-retardant performance at about 200° C. may degrade.

As used herein, the term “about” refers to a value within 1% of the recited value. When used with respect to temperature “about” refers to a temperature within 1 degrees of the recited temperature.

In one embodiment, the phosphorus-based additive comprises a phosphate-based compound. As used herein, the term “phosphate-based compound” refers to a compound containing phosphate. In certain embodiments, the phosphate-based compound may be an organic phosphate compound. According to one embodiment, the phosphorus-based additive may be or consist of a phosphate-based compound. According to another embodiment, the phosphorus-based additive may include at least one phosphate-based compound but optionally other phosphorus-based compounds.

In embodiments in which the phosphorus-based additive comprises a phosphate-based compound, the phosphate-based compound may be represented by Chemical Formula 1 below:

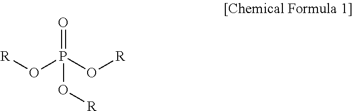

In Chemical Formula 1, three functional groups R are independent of one another. Each R may be hydrogen or a functional group having 1 to 30 carbon atoms. Preferably, each R may independently be hydrogen or a functional group having 1 to 26 carbon atoms; such as 1 to 12 carbon atoms, 1 to 9 carbon atoms, or 1 to 6 carbon atoms.

In certain embodiments, at least one of the three R groups is not hydrogen. In other words, at least one R is independently a functional group having 1 to 30 carbon atoms. In certain embodiments, none of the three R groups are hydrogen (each is independently a functional group having 1 to 30 carbon atoms).

In certain embodiments, the functional group is independently a hydrocarbyl group. As used herein, “hydrocarbyl” refers to a univalent organic radical containing carbon and hydrogen, formed by removing one hydrogen atom from a hydrocarbon, such as alkyl, alkenyl, alkynyl, and aryl radicals. From the viewpoint of chemical stability, the functional group may be an alkyl group. Each functional group may independently be linear, branched, cyclic, or any combination thereof. According to another embodiment, each R may be optionally substituted with a heteroatom. For example, each R may be independently substituted with one or more of O, N, S, P, B, F, Cl, Br, I, or any combination thereof. In certain embodiments, one or more R is independently substituted with one or more halogen atoms. For example, one or more R may independently be a halogen-substituted alkyl group. In certain embodiments, one or more R is independently substituted with one or more fluorine (F) atoms.

In certain embodiments, the total number of carbon atoms in the compound may be 1 to 30. This means that one molecule having the structure of Chemical Formula 1 contains 1 to 30 carbon atoms. In certain embodiments, the total number of carbon atoms may be 1 to 24, 1 to 12, 1 to 9, or 1 to 6.

According to one embodiment, at least two of the three R groups may be identical functional groups. In certain embodiments, all the three R groups may be identical functional groups.

Further encompassed within the scope of the presently disclosed additive compositions are those having more than one phosphorus-based additive. Thus, references to “a” or “the” “phosphorus-based additive” or “phosphate-based additive” also includes embodiments having two or more phosphorus-based additives or phosphate-based additives, for example, each independently a compound represented by Chemical Formula 1, but with different R groups. Accordingly, a phosphorus-based additive may have an average molecular weight (e.g., number-average molecular weight or weight-average molecular weight) of about 500 g/mol or less, such as about 100 to about 500 g/mol, about 100 to about 400 g/mol, about 100 to about 300 g/mol, or about 150 to about 300 g/mol. Such a composition may also have an average number of carbon atoms, for example, about 1 to about 30, about 1 to about 24, about 1 to about 12, about 1 to about 9, or about 1 to about 6.

The additive composition of the present disclosure also comprises a silicon-based additive. The silicon-based additive may generate silica through an oxidative reaction during thermal decomposition. The silica thus formed may contribute to suppressing fire propagation by blocking oxygen in the air and inhibiting flames.

The type of silicon-based additive is not particularly limited, provided that it is capable of performing the function described above. From the perspective of immersion cooling, the silicon-based additive is likewise not particularly limited, so long as it can perform the above-described role without impairing the immersion cooling performance of a thermal management fluid applied to electronic products.

For example, the silicon-based additive may have a molecular weight of equal to or less than about 2,000 g/mol. In one embodiment, the molecular weight of the silicon-based additive may be about 500 to about 1,800 g/mol, about 500 to about 1,600 g/mol, about 600 to about 1,500 g/mol, or about 700 to about 1,400 g/mol.

In certain embodiments, the decomposition temperature of the silicon-based additive may be about 150° C. to about 450° C., about 170° C. to about 320° C., about 180° C. to about 300° C., or about 200° C. to about 270° C. When the ambient temperature reaches the decomposition temperature, the silicon-based additive may undergo thermal decomposition and perform a flame-retardant function. However, when the molecular weight of the silicon-based additive deviates from the above-described range, the flame-retardant performance within the temperature range of about 200° C. to about 270° C. may degrade.

The silicon-based additive may comprise a polysiloxane compound. According to one embodiment, the silicon-based additive may be (e.g., consist of) or comprise a polysiloxane compound. According to another embodiment, the silicon-based additive comprises at least one polysiloxane compound. In certain embodiments, the polysiloxane compound is a liquid at room temperature, and more in certain embodiments, may be a silicone oil.

In embodiments in which the silicon-based additive comprises a polysiloxane compound, the polysiloxane compound may be represented by Chemical Formula 2 below:

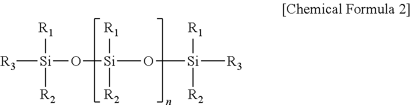

In Chemical Formula 2, functional groups R₁, R₂, and R₃ may each independently be selected from the group consisting of hydrogen, a hydroxyl group, an alkyl group, an alkenyl group, an alkynyl group, an aryl group, and an alkoxy group. Additionally, in Chemical Formula 2 above, n is an integer of equal to or greater than 1.

The alkyl group may be a functional group having 1 to 10 carbon atoms, 1 to 8 carbon atoms, 1 to 6 carbon atoms, or 1 to 4 carbon atoms. In certain embodiments, the alkyl group may be a methyl group or an ethyl group. The alkenyl group and alkynyl group may each be functional groups having 2 to 10 carbon atoms, 2 to 8 carbon atoms, 2 to 6 carbon atoms, or 2 to 4 carbon atoms. For example, the alkenyl group may be a vinyl group. According to one embodiment, the aryl group may be a phenyl group. The alkoxy group may be a functional group having 1 to 10 carbon atoms, 1 to 8 carbon atoms, 1 to 6 carbon atoms, or 1 to 4 carbon atoms. For example, the alkoxy group may be a methoxy group or an ethoxy group.

According to one embodiment, R₁, R₂, and R₃ may each independently be alkyl groups. In certain embodiments, R₁, R₂, and R₃ are identical alkyl groups. In certain embodiments, each of R₁, R₂, and R₃ are methyl groups.

According to another embodiment, R₁ and R₂ may be different functional groups. In certain embodiments, R₁ may be an alkyl group and R₂ may be an aryl group (or vice versa). In certain embodiments, R₃ may be an alkyl group.

In Chemical Formula 2 above, n may be an integer equal to or greater than 1. According to one embodiment, n may be 1 to 30, 3 to 20, or 5 to 16. According to another embodiment, n may be determined depending on the desired flash point of polysiloxane and the type of functional group selected. For example, when R₁, R₂, and R₃ are all methyl groups, n may be in a range of 8 to 16.

As will be recognized by a skilled artisan, the silicon-based additive may comprise a mixture of compounds of Chemical Formula 2, with varying R₁, R₂, and R₃ group and varying molecular weight. Accordingly, such a silicon-based additive composition may have an average molecular weight (e.g., number-average molecular weight, weight-average molecular weight, or viscosity-average molecular weight) of about 2,000 g/mol or less, such as about 500 to about 1,800 g/mol, about 500 to about 1,600 g/mol, about 600 to about 1,500 g/mol, or about 700 to about 1,400 g/mol. Such a composition may also have an average value of “n”, for example, about 1 to about 30, about 3 to about 20, or about 5 to about 16.

In the additive composition, the phosphorus-based additive and the silicon-based additive may be uniformly mixed in an appropriate ratio. According to one embodiment, the weight ratio of the phosphorus-based additive to the silicon-based additive in the composition may be about 1:6 to about 10:1. The simultaneous use of these two different additives allows the chemical fire suppression effect provided by the phosphorus-based additive and the oxygen-deprivation or exclusion (smothering) fire suppression effect provided by the silicon-based additive to be achieved concurrently. Without wishing to be bound by theory, when the weight ratio of the phosphorus- and silicon-based additives deviates from the above-described range, the flame-retardant effect resulting from addition of the additive composition may be reduced.

Use of the additive composition in a thermal management fluid may increase the flash point of the thermal management fluid. Additionally, such use may contribute to interrupting free-radical chain reactions and reducing the likelihood of contact with oxygen in air, thereby preventing fire propagation in the thermal management fluid.

According to one embodiment, the additive composition may increase the flash point of the thermal management fluid by at least 5° C. (ΔFP≥5° C.). Here, the ΔFP is defined as: ΔFP=(flash point of a fluid containing the additive composition)-(flash point of a fluid not containing the additive composition). In the present disclosure, the flash point of the thermal management fluid is measured in accordance with ASTM D93. The ΔFP of the thermal management fluid is a value calculated when the additive composition is added to the thermal management fluid at a weight of about 4 to about 15 wt % based on the total weight of the thermal management fluid composition. In certain embodiments, the additive composition can increase the flash point of a thermal management fluid (ΔFP) by about 5° C. to about 60° C., by about 10° C. to about 50° C., or by about 15° C. to about 50° C.

The additive composition described above may be incorporated into a conventional thermal management fluid and is expected to, when thermal runaway occurs in an electronic product including a battery module, more effectively suppress fire propagation to adjacent battery cells within the module, thereby providing safety improvements such as prevention of large-scale fires. Additionally, since the additive composition improves the flash point of the thermal management fluid, base oils that were previously unsuitable for use in thermal management fluids due to low flash points may become usable. Accordingly, the additive composition is expected to provide the effect of broadening the selection range of base oils for thermal management fluids.

### Thermal Management Fluid Composition

Another aspect of the present disclosure provides a thermal management fluid composition comprising the above-described phosphorus- and silicon-based additives. Hereinafter, unless otherwise specified, the descriptions provided above with respect to the additives may be equally applicable, and redundant descriptions may be omitted.

The thermal management fluid compositions disclosed herein comprise a base oil, a phosphorus-based additive (e.g., as described according to any embodiment disclosed herein), and a silicon-based additive (e.g., as described according to any embodiment disclosed herein). Such a thermal management fluid composition possesses physical properties such as excellent electrical insulation performance and cooling performance, enabling direct contact with an electronic product to cool the electronic product. Accordingly, according to one embodiment, such a thermal management fluid composition may be used for immersion cooling.

Regarding the base oil, any conventional or future base oil suitable for use as a thermal management fluid may be employed. That is, any oil compatible with both traditional, petroleum-refined base stocks (API Group I/II) and advanced, synthetic or next-generation base stocks (Group III/IV/V) may be used. For example, suitable base oils include mineral oil, synthetic oil, vegetable oil, or any combination thereof. As used herein, mineral oil refers to an oil derived from crude oil without undergoing a separate synthetic process. In the present disclosure, mineral oil may be or comprise base oils corresponding to American Petroleum Institute (API) Groups I to III. The synthetic oil may comprise polyalphaolefin (PAO), gas-to-liquid (GTL) base oil, coal-to-liquid (CTL) base oil, or ester-based oil.

In one embodiment, the thermal management fluid composition may comprise about 85 to about 98 wt % of the base oil, equal to or less than about 10 wt % of the phosphorus-based additive, and equal to or less than about 10 wt % of the silicon-based additive, based on the total weight of the composition. Without wishing to be bound by theory, when the content of the base oil exceeds about 98 wt %, the effect of the phosphorus- and silicon-based additives weaken in their intended functions. However, when the content of the base oil is less than 85 wt %, the additives may not be fully dissolved in the base oil, which may degrade the performance of the additives.

As noted above, the content of the phosphorus-based additive in the thermal management fluid composition may be equal to or less than 10 wt %. In certain embodiments, the content of the phosphorus-based additive in the thermal management fluid composition may be greater than 0 to but no more than about 10 wt %, about 1 to about 10 wt %, or about 1 to about 9 wt %. Without wishing to be bound by theory, when the phosphorus-based additive in the thermal management fluid composition is at least about 1 wt %, fire propagation suppression performance may be improved. However, when the content of the phosphorus-based additive in the thermal management fluid composition exceeds the above numerical range, the phosphorus-based additive may not be fully dissolved in the thermal management fluid composition and may remain in the form of droplets within the base oil. Such non-uniform dissolution of the phosphorus-based additive may cause a degradation in fire propagation prevention performance.

As noted above, the content of the silicon-based additive in the thermal management fluid composition may be equal to or less than about 10 wt %. In certain embodiments, the content of the silicon-based additive in the thermal management fluid composition may be greater than 0 to about 10 wt %, about 0.5 to about 10 wt %, or about 1 to about 10 wt %. Without wishing to be bound by theory, when the silicon-based additive in the thermal management fluid composition is at least about 1 wt %, fire propagation suppression performance may be improved. However, when the content of the silicon-based additive in the thermal management fluid composition exceeds the above numerical range, the silicon-based additive may not be fully dissolved in the thermal management fluid composition.

In any embodiment, the thermal management fluid composition may further comprise an additive other than and additional to the phosphorus- and silicon-based additives described herein. In the present disclosure, such an additional additive is referred to as a third additive in order to distinguish it from the phosphorus-based additive (first additive) and the silicon-based additive (second additive). The third additive is not particularly limited, provided that it is usable for improving the physical properties of the thermal management fluid composition. For example, the third additive may comprise an antioxidant, an anti-foaming agent, a corrosion inhibitor, a detergent, a dispersant, a friction modifier, an anti-wear agent, an extreme-pressure additive, a viscosity index improver, a pour-point depressant, a viscosity modifier, or any combination thereof.

The content of the third additive in the thermal management fluid composition may be equal to or less than about 2 wt %. In certain embodiments, the content of the third additive in the thermal management fluid composition may be about 0.1 to about 2 wt %, about 0.5 to about 2 wt %, or about 0.5 to about 1.5 wt %.

As described above, the flash point of the thermal management fluid composition may be improved (increased) by the addition of the aforementioned additives to the thermal management fluid. According to one embodiment, the flash point of the thermal management fluid composition (comprising the phosphorus- and silicon-based additives and optionally one or more third additives) may be at least about 200° C. In certain embodiments, the flash point of the thermal management fluid composition may be about 200° C. to about 250° C., about 200° C. to about 240° C., or about 200° C. to about 230° C. In certain embodiments, the thermal management fluid composition may employ a base oil having a relatively low viscosity. In this case, the flash point of such a thermal management fluid composition may differ from the above-described range. In certain embodiments, the flash point of the thermal management fluid composition is not less than about 200° C.

Use of the thermal management fluid composition of the present disclosure, which includes the additives described above, may reduce the likelihood of fire propagation during battery thermal runaway in an electronic product not only through physical fire suppression such as oxygen deprivation (smothering), but also through chemical fire suppression. Accordingly, when used as an immersion-cooling thermal management fluid, the thermal management fluid composition is expected to mitigate damage in the event of a battery fire.

Additional description of the embodiments of the present disclosure will be provided below with reference to specific experimental examples. However, the following examples and comparative examples included in the experimental examples are only given for illustrating the embodiments and do not limit the appended claims. It will be apparent to those skilled in the art that various modifications and alterations of the examples may be made without departing from the scope and spirit of the present disclosure. These modifications and alterations will fall within the appended claims.

### EXAMPLES

### 1. Preparation of Thermal Management Fluid Composition

A thermal management fluid composition was prepared by combining a base oil and additives. As the base oil, YUBASE 3 was used, which has a flash point of about 184° C. measured according to ASTM D93, a kinematic viscosity at 40° C. of 12.4 cSt, and a kinematic viscosity at 100° C. of 3.1 cSt.

As a phosphorus-based additive, triethyl phosphate, having a flash point of about 124° C. measured in accordance with ASTM D93, or tributyl phosphate, having a flash point of about 145° C. measured in accordance with ASTM D93, was used. As a silicon-based additive, polydimethylsiloxane, having a kinematic viscosity of 10 cSt at 25° C. and a flash point of about 170° C. measured in accordance with ASTM D93, was used.

The content of each compositional component in Examples 1 to 3 and Comparative Examples 1 to 3 is presented in Table 1 below.

TABLE 1

| | Comparative | Comparative | Comparative | Example | Example | Example |
|---|---|---|---|---|---|---|
| | Example 1 | Example 2 | Example 3 | 1 | 2 | 3 |
| Base oil | 100 wt % | 97.5 wt % | 90 wt % | 92 wt % | 87 wt % | 94.5 wt % |
| Triethyl phosphate | — | 2.5 wt % | — | 5 wt % | — | 2.5 wt % |
| Tributyl phosphate | — | — | — | — | 10 wt % | — |
| Polydimethylsiloxane | — | — | 10 wt % | 3 wt % | 3 wt % | 3 wt % |

### 2. Performance Evaluation of Prepared Thermal Management Fluid Compositions

### (1) Flash Point Measurement

The flash point of each of the thermal management fluid compositions of the above Comparative Examples and Examples was measured and the results are presented in Table 2 below. The flash point measurement was performed in accordance with ASTM D93.

### (2) Battery Cell Fire Propagation Test

Three cylindrical battery cells were installed at three locations among cell holders in a test module, and heating pads were attached to the surfaces of the cells. The assembled module was then fully immersed in each of the thermal management fluid compositions of Comparative Examples 1 and 3 and Examples 1 and 2. Subsequently, the heating pads were activated to sequentially induce thermal runaway and explosion of the three cells. During each explosion event, the flame size and flame duration were measured. The flame size (diameter) was determined at the moment of maximum flame expansion, using explosion footage recorded by a camera installed at the top of the test module. The results are presented in Table 2 below.

TABLE 2

| | Comparative | Comparative | Comparative | Example | Example | Example |
|---|---|---|---|---|---|---|
| | Example 1 | Example 2 | Example 3 | 1 | 2 | 3 |
| Base oil | 100 wt % | 97.5 wt % | 90 wt % | 92 wt % | 87 wt % | 94.5 wt % |
| Flash | 184 | 214 | 184 | 206 | 230 | 204 |
| point (° C.) | | | | | | |
| Flame | 130 | — | 150 | Barely | Barely | — |
| size (mm) | | | | observed | observed | |
| Flame | 4.64 | — | 0.74 | 0.40 | 0.19 | — |
| duration | | | | | | |
| (s) | | | | | | |

Referring to Table 2, the flash points of the Example thermal management fluid compositions comprising the additive composition of the present disclosure were significantly increased compared to that of the Comparative Example 1 thermal management fluid composition, which included no additive. It can also be found that use of the additive composition of the present disclosure in a thermal management fluid could reduce both the flame size and flame duration, thereby contributing to the prevention of fire propagation.

The additive composition of the present disclosure may be readily applicable to conventional thermal management fluids and is expected to contribute to preventing battery thermal runaway and fire propagation, particularly when utilized in immersion cooling of electronic products such as electric vehicles (EVs) or energy storage systems (ESS) including high-capacity batteries.

The foregoing description is merely an example of applying the principles of the present disclosure, and other configurations may be further included without departing from the scope of the present disclosure.

What is claimed is:

1. An additive composition for a thermal management fluid, the additive composition comprising:
a phosphorus-based additive; and
a silicon-based additive.

2. The additive composition of claim 1, wherein the phosphorus-based additive has a molecular weight of about 100 g/mol to about 500 g/mol.

3. The additive composition of claim 1, wherein the phosphorus-based additive comprises a compound represented by Chemical Formula 1 below: 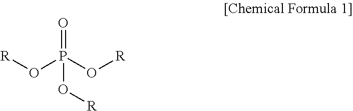
wherein:
each R is independently hydrogen or a functional group having 1 to 30 carbon atoms,
at least one R is not hydrogen, and
a total number of carbon atoms in the compound is 1 to 30.

4. The additive composition of claim 3, wherein each functional group is independently a hydrocarbyl group.

5. The additive composition of claim 1, wherein the silicon-based additive comprises a compound represented by Chemical Formula 2 below: 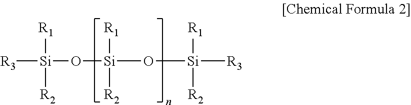
wherein:
functional groups R₁, R₂, and R₃ are each independently selected from the group consisting of hydrogen, a hydroxyl group, an alkyl group, an alkenyl group, an alkynyl group, an aryl group, and an alkoxy group, and
n is an integer of equal to or greater than 1.

6. The additive composition of claim 5, wherein R₁ is an alkyl group or an aryl group, and R₂ and R₃ are each independently alkyl groups.

7. The additive composition of claim 1, wherein a weight ratio of the phosphorus-based additive to the silicon-based additive is about 1:6 to about 10:1.

8. A thermal management fluid composition, comprising:
a base oil;
a phosphorus-based additive; and
a silicon-based additive.

9. The thermal management fluid composition of claim 8, wherein the base oil comprises mineral oil, synthetic oil, vegetable oil, or a combination thereof.

10. The thermal management fluid composition of claim 8, comprising:
about 85 wt % to 98 wt % of the base oil;
equal to or less than about 10 wt % of the phosphorus-based additive; and
equal to or less than about 10 wt % of the silicon-based additive.

11. The thermal management fluid composition of claim 8, wherein the thermal management fluid composition has a flash point of at least about 200° C.

12. The thermal management fluid composition of claim 8, further comprising: a third additive, wherein the third additive comprises an antioxidant, an anti-foaming agent, a corrosion inhibitor, a detergent, a dispersant, a friction modifier, an anti-wear agent, an extreme-pressure additive, a viscosity index improver, a pour-point depressant, a viscosity modifier, or any combination thereof.

13. The additive composition of claim 1, wherein the phosphorus-based additive comprises triethyl phosphate, tributyl phosphate, or a combination thereof.

14. The additive composition of claim 1, wherein the silicon-based additive comprises polydimethylsiloxane.

15. The additive composition of claim 5, wherein R₁, R₂, and R₃ are each a methyl group, and n is in a range of 8 to 16.

16. A method of improving fire propagation prevention in a thermal management fluid, comprising adding the additive composition of claim 1 to a base oil.

17. A method of immersion cooling an electronic device, comprising contacting the device with the thermal management fluid composition of claim 8.

18. A method of increasing the flash point of a thermal management fluid by at least 5° C., comprising adding the additive composition of claim 1 to the thermal management fluid.
